(19) United States
(12) Patent Application Publication
(10) Pub. No.: US 2026/0322678 A1
(43) Pub. Date: Oct. 15, 2026

(54) RESOLVING NETWORK DEVICE SERVICEABILITY

(71) Applicant: Arista Networks, Inc., Santa Clara, CA (US)

(72) Inventor: Rachit Srivastava, Pune (IN)

(21) Appl. No.: 19/175,477

(22) Filed: Apr. 10, 2025

(51) Int. Cl. H04L 41/0604; H04L 41/0654; H04L 43/16

(52) U.S. Cl. CPC H04L 41/0622; H04L 41/0654; H04L 43/16

(57) ABSTRACT

Techniques to resolve network device serviceability involve receiving a transmission from a network device. The transmission indicates a duration of time over which the network device has remained serviceable. The technique further involves accessing a previous timestamp from computerized memory. The previous timestamp indicates a previous time when the network device was confirmed to be serviceable. The technique further involves, based on the transmission and the previous timestamp, performing a serviceability resolution operation that provides a serviceability result indicating whether the network device has remained serviceable since the previous time when the network device was confirmed to be serviceable. Such resolving techniques are suitable even for situations in which connectivity with the network device is lost and re-established, and/or in which the network device becomes unserviceable for a period of time.

### BACKGROUND

In a conventional network, an originating network node may periodically send a heartbeat packet to a destination network node. When the destination network node receives a heartbeat packet from the originating network node, the destination network node concludes that the originating network node is running.

However, suppose that the destination network node does not receive a heartbeat packet from the originating network node during an anticipated arrival period. In such a situation, the destination network node may conclude that the originating network node is not running, e.g., that it has failed or shutdown.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a diagram of an example environment in which network device serviceability is resolved in accordance with one or more embodiments.

FIG. 2 is a diagram of a network device in accordance with one or more embodiments.

FIG. 3 is a flowchart of a procedure performed by a network device in accordance with one or more embodiments.

FIG. 4 is a diagram of a server device in accordance with one or more embodiments.

FIG. 5 is a flowchart of a procedure performed by a server device in accordance with one or more embodiments.

FIG. 6 is a first example timeline of network device operating status from which a server device is able to resolve network device serviceability in accordance with one or more embodiments.

FIG. 7 is a second example timeline of network device operating status from which a server device is able to resolve network device serviceability in accordance with one or more embodiments.

FIG. 8 is a third example timeline of network device operating status from which a server device is able to resolve network device serviceability in accordance with one or more embodiments.

FIGS. 9 to 13 are additional example timelines of network device operating status from which a server device is able to resolve network device serviceability in accordance with one or more embodiments.

### DETAILED DESCRIPTION

### Overview

Unfortunately, the failure of a destination network node to receive a heartbeat packet from an originating network node within an anticipated arrival period does not necessarily mean that the originating network node is not running. Rather, the originating network node may still be running, but an unrelated disruption in the network may have occurred, which prevented the destination network node from receiving the heartbeat packet within the anticipated arrival period. For example, the network may have a firewall that receives improper configuration information which results in the firewall blocking the heartbeat packet from reaching the destination network node. As another example, other equipment within the network such as cabling, power supplies, another network node, combinations thereof, etc., may fail or provide flakey behavior which prevents the heartbeat packet from being delivered to the destination network node even though the originating network node remains fully operational.

If there is an incorrect conclusion that the originating network node is not running, resources (e.g., reallocated compute cycles, memory, bandwidth, etc.) may be wasted in attempting to address this misdiagnosis rather than the actual cause of the problem. Along these lines, the misdiagnosis may lead to inappropriate failover/reconfiguration activity, extended network downtime/delays, unnecessary equipment replacement work, continuing problems, and so on. What is needed, therefore, is a way to effectively determine whether a network device has remained serviceable (remained available/running) even if the network device appeared to be unserviceable (appeared to be unavailable/not running) for a period of time.

The above need is addressed at least in part by a technique that resolves the question of whether a network device has remained serviceable when it appears that the network device may have been unserviceable or unavailable for an amount of time before communication with the network device is re-established. Along these lines, the network device may provide a transmission that includes an uptime value indicating a duration of time over which the network device has remained serviceable. Using this uptime value and a timestamp that indicates a previous time when the network device was confirmed to be serviceable, a serviceability resolution operation may be performed. Such an operation may provide a serviceability result that indicates whether the network device has remained serviceable since the previous time when the network device was confirmed to be serviceable. If the network device has remained serviceable since the previous time, it is possible that another network issue may have contributed to the appearance that the network device was unserviceable.

Serviceability (or availability) of a network device refers to a condition in which the network device is fully up (powered up and booted), and ready to perform network operations. When the network device is in such a condition, the network device is available and properly functioning (e.g., is turned on, is booted, responds/operates as designed/configured, is not unavailable while in the midst of performing a firmware update, is not purposefully disabled, etc.).

For example, in a situation in which the network device is a wireless (or Wi-Fi) access point (WAP), the network device is serviceable when it has powered up and booted, and is ready and available to serve wireless devices (or Wi-Fi clients). The network device is unserviceable when it is not ready (or unavailable) to serve the wireless devices such as when the WAP is powered down, is in the process of booting, is in the process of updating its firmware, etc.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

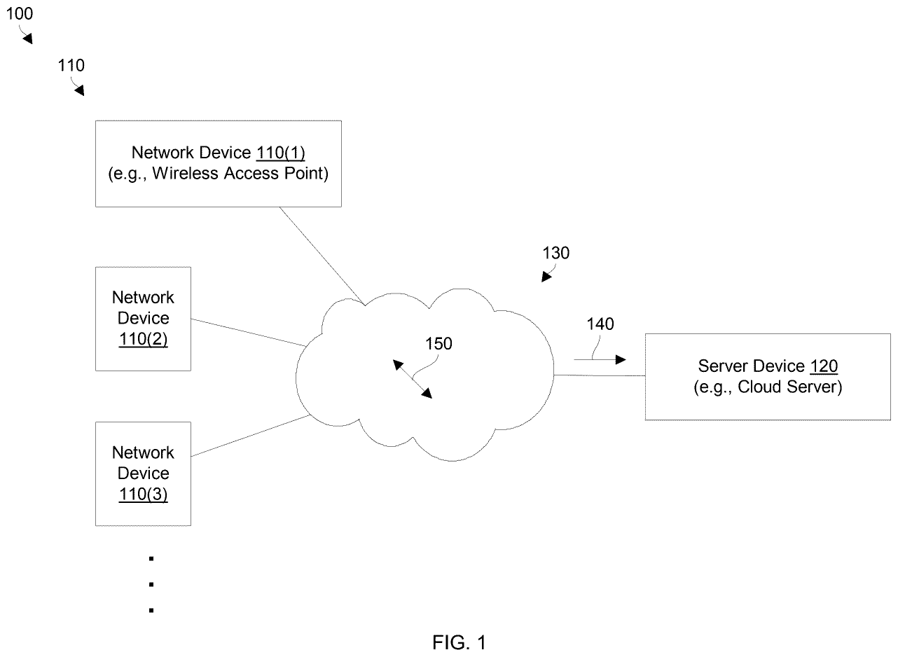

FIG. 1 shows an example network environment 100 in which network device serviceability is resolved in accordance with one or more embodiments. The example network environment (or simply network) 100 includes network devices 110(1), 110(2), 110(3), . . . (collectively, network devices 110), a server device 120, and a communications medium 130. It should be appreciated that the network environment 100 may be a portion of an even larger network environment.

The network devices 110 are constructed and arranged to perform useful work. Along these lines, the network devices 110 may perform networking operations such as receiving communications from and/or transmitting communications to other devices (e.g., user devices, other network devices, specialized equipment, etc.). Such conveyance of communications may involve the use of physical ports, fiber optic equipment, wireless transceiver circuitry, combinations thereof, etc. Additionally or alternatively, the network devices 110 may perform other work such as network traffic load balancing, fault tolerance, security, management, and so on. During such time, the network devices 110 may become serviceable when the network devices 110 power up, boot, and become ready and available to perform operations as designed/configured.

Nevertheless, it should be appreciated that the network devices 110 may become unserviceable although such situations could be infrequent or rare. Along these lines, from time to time, a network device 110 may receive a new firmware update (or upgrade) which requires the network device 110 to go offline temporarily (e.g., to stop operating in accordance with old firmware and to begin operating in accordance with new firmware). Additionally, a network device 110 may have been powered down (e.g., due to loss of street power and/or backup power, for maintenance, etc.) and may now be in the process of rebooting. Other situations may have caused a network device 110 to become temporarily unserviceable (e.g., due to a reset, due to a software error, etc.).

As will be explained in further detail shortly, the network devices 110 are further constructed and arranged to routinely communicate with the server device 120 (perhaps through one or more other network devices 110) while the network devices 110 are serviceable in order to enable the server device 120 to resolve network device serviceability. Along these lines, while the network devices 110 are operational (or available/serviceable) to perform networking operations, the network devices 110 send messages (or similar types of transmissions) 140 to the server device 120 at routine intervals (e.g., every 30 minutes, every hour, every 90 minutes, etc.). As will be explained in further detail shortly, the messages 140 contain serviceability information (e.g., enabling the server device 120 to ascertain lengths of time during which the network devices 110 have remained serviceable).

The server device 120 is constructed and arranged to resolve network device serviceability. Along these lines, the server device 120 processes the messages 140 received from the network devices 110 in order to resolve serviceability of the network devices 110 on an individual (or per network device 110) basis.

It should be understood that the server device 120 may reside in a variety of locations relative to the network devices 110. Along these lines, the server device 120 may be local relative to one or more of the network devices 110 such as within the same local area network (LAN). Additionally or alternatively, the server device 120 may be further away from one or more of the network devices 110 (e.g., miles apart) such as simply within the same wide area network (WAN). Again, additionally or alternatively, the server device 120 and one or more of the network devices 110 may be simply connected together over the Internet (e.g., the server device 120 may reside in a remote server farm or in the cloud), etc.

The communications medium 130 is constructed and arranged to connect the various devices of the network environment 100 together to enable equipment within the network environment 100 to exchange electronic signals 150 with each other. At least a portion of the communications medium 130 is illustrated as a cloud to indicate that the communications medium 130 is capable of having a variety of different topologies, including hub and spoke, backbone, irregular, other topologies, combinations thereof, and so on. It should be appreciated that the communications medium 130 may include copper based data communications devices and copper cabling, fiber optic devices and fiber cabling, wireless devices, combinations thereof, etc. Furthermore, the communications medium 130 is capable of supporting various communications protocols such as the Transmission Control Protocol (TCP), Internet Protocol (IP), User Datagram Protocol (UDP), and so on.

During operation, the network devices 110 boot up and then operate to perform networking operations (or other useful work). While the network devices 110 are serviceable (up and running), one or more of the network devices 110 may transmit messages 140 containing serviceability information to the server device 120 at regular time intervals.

For example, when the network device 110(1) is initially powered on, circuitry within the network device 110(1) may perform a variety of operations prior to the network device 110(1) becoming serviceable. Along these lines, the network device 110(1) may execute firmware, perform self-tests, load configuration information and operating code, and perhaps perform other booting operations (e.g., start services, create/open files, etc.).

Once the network device 110(1) has finished booting, the network device 110(1) is ready to perform network device operations and is considered serviceable. For example, in the context of a WAP, the network device 110(1) is operable to exchange wireless communications with wireless devices and a wired network.

Additionally, once the network device 110(1) becomes serviceable, the network device 110(1) begins sending periodic transmissions to the server device 120 to enable the server device 120 to resolve network device serviceability. Along these lines, the network device 110(1) is equipped with a time tracking mechanism that enables identification of the amount of time that elapses while the network device 110(1) remains serviceable. While the network device 110(1) performs networking operations, the network device 110 periodically sends a message 140 which includes the amount of elapsed time to the server device 120 through the communications medium 130.

The time interval between messages 140 may be controlled by a predefined operating parameter (e.g., every 30 minutes, every hour, every 90 minutes, etc.). Within the messages 140, the network device 110(1) includes serviceability information such as the current time on the network device 110(1) (wall clock or device time) and a current reading from the time tracking mechanism (the amount of elapsed time).

In response to receipt of the messages 140 from the network device 110(1), the server device 120 is able to resolve whether the network device 110(1) has remained serviceable since a previous time when the network device 110(1) was confirmed to be serviceable. It should be understood that similar operations may occur for the other network devices 110 to resolve serviceability for the other network devices 110 as well.

### Network Device Details

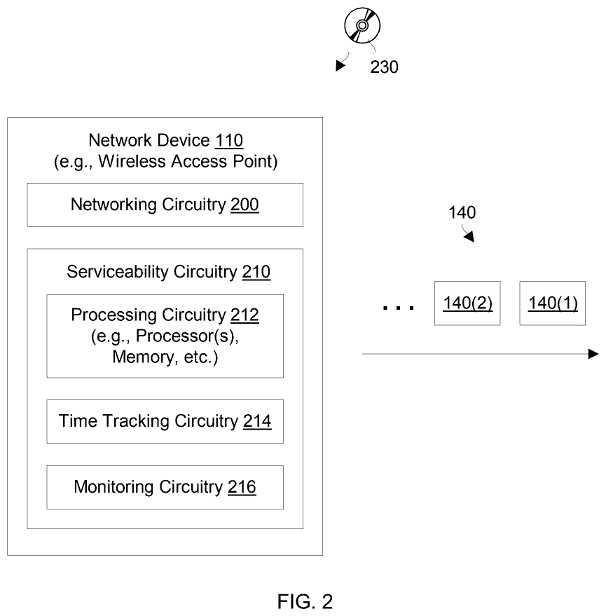

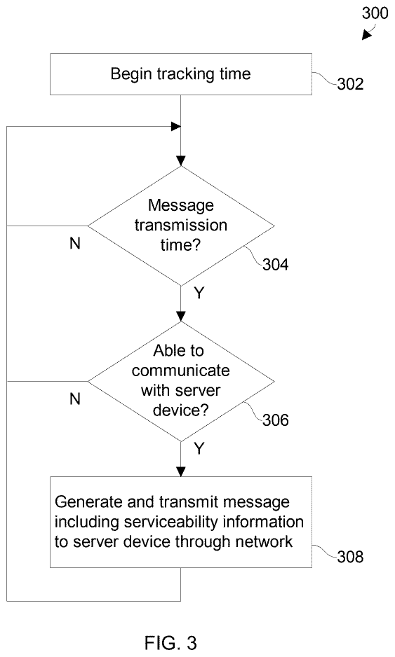

FIGS. 2 and 3 provide certain details of a network device 110 (e.g., also see FIG. 1) in accordance with certain embodiments. FIG. 2 shows certain componentry details for the network device 110. FIG. 3 shows a flowchart of a procedure performed by the network device 110.

As shown in FIG. 2, the network device 110 includes networking circuitry 200 and serviceability circuitry 210 coupled with the networking circuitry 200. When the network device 110 is considered serviceable, both the networking circuitry 200 and serviceability circuitry 210 are operational.

The networking circuitry 200 is constructed and arranged to perform networking operations. For example, in the context of a WAP, the networking circuitry 200 is operable to connect wireless devices to a wired network. Along these lines, the networking circuitry 200 may convey messages (e.g., packets) among wireless devices which are within range, may convey messages between the wireless devices and other network devices 110 (e.g., also see FIG. 1), may communicate with non-network devices through the wired network, combinations thereof, and so on.

The serviceability circuitry 210 is constructed and arranged to routinely communicate (perhaps through the networking circuitry 200) with the server device 120 (also see FIG. 1). Along these lines, while the networking circuitry 200 is operational (or serviceable to perform networking operations), the serviceability circuitry 210 periodically generates and transmits a message 140 containing serviceability information to the server device 120. As mentioned earlier and as will be further discussed shortly, the messages 140 (e.g., messages 140(1), 140(2), . . . ), which are sent by the network device 110 and received by the server device 120, enable the server device 120 to resolve network device serviceability.

As further shown in FIG. 2, the serviceability circuitry 210 of the network device 110 includes processing circuitry 212, time tracking circuitry 214, and monitoring circuitry 216. Although the processing circuitry 212, the time tracking circuitry 214, and the monitoring circuitry 216 are depicted as individual components, such componentry may share or even be formed by one or more of the same resources (e.g., a microprocessor chip set, memory, etc.).

The processing circuitry 212 is constructed and arranged to provide main control for the serviceability circuitry 210. Along these lines and as will be explained in further detail shortly with reference to FIG. 3, the processing circuitry 212 performs a specialized procedure to prepare and send messages 140 to the server device 120. Such a message 140 includes serviceability information such as a current timestamp indicating the current time (or wall clock time) on the network device 110 and an uptime parameter indicating the amount of time that has elapsed since the network device 110 became serviceable.

An example format for a message 140 that is periodically sent from the network device 110 to the server device 120 is as follows:
Message:
   {
      Timestamp,
      Uptime,
      Disconnection_List
         [
         <T_{offline_start_1}, T_{offline_end_1}>,
         <T_{offline_start_1}, T_{offline_end_2}>,
         . . . ,
         T_{offline_start_n}, To_{offline_start_n},
         ]
   }
      In this example format, Timestamp is a parameter (or metric) within the message 140 that indicates the current time (or wall clock time) on the network device 110. Uptime is a parameter within the message 140 that indicates a duration of time over which the network device 110 has remained serviceable. Disconnection_List is a list of disconnection entries within the message 140 that identifies disconnection time intervals, defined by interval endpoints T_{offline_start_k} and T_{offline_end_k}, during which connectivity between the network device 110 and the server device 120 was lost.

It should be appreciated that the term “time” refers to the combination of a time of day and a date. Accordingly, the current time represented by the Timestamp refers to a particular time of day on a particular date.

It should be understood that the memory which stores the list of disconnection entries (Disconnection_List) for the message 140 is non-volatile storage (e.g., also see the processing circuitry 212 in FIG. 2). Accordingly, the list of disconnection entries persists even if the network device 110 is powered down (e.g., if the network device is turned off, loses power, etc.).

The time tracking circuitry 214 is constructed and arranged to provide the Uptime parameter to the processing circuitry 212. Along these lines, the time tracking circuitry 214 may be implemented in a variety of ways.

In some embodiments, the time tracking circuitry 214 includes a timer (or counter), and the processing circuitry 212 starts the timer when the network device 110 becomes serviceable. Accordingly, the timer provides the Uptime parameter as an output. If the network device 110 becomes unserviceable, the processing circuitry 212 directs the time tracking circuitry 214 to restart (or reset) the timer when the network device 110 becomes serviceable again.

In other embodiments, the time tracking circuitry 214 includes a memory location and a time computation circuit. When the network device 110 becomes serviceable, the processing circuitry 212 directs the time tracking circuitry 214 to store (or write) a starting timestamp from a local clock circuit (e.g., a circuit that outputs wall clock time) into the memory location. In response to commands from the processing circuitry 212, the time tracking circuitry 214 is then able to output the Uptime parameter by computing the Uptime parameter as the time difference between the current time from the local clock circuit and the starting timestamp stored in the memory location. If the network device 110 becomes unserviceable, the processing circuitry 212 directs the time tracking circuitry 214 to store a new starting timestamp from the local clock circuit into the memory location when the network device 110 becomes serviceable again. Other time tracking mechanisms are suitable for use as well for the time tracking circuitry 214.

The monitoring circuitry 216 is constructed and arranged to monitor whether the network device 110 is able to communicate with the server device 120. Along these lines, the monitoring circuitry 216 may employ one or more tools to confirm connectivity with the server device 120 (e.g., via bidirectional forwarding detection, ping, other communications with the server device 120, combinations thereof, etc.). When the monitoring circuitry 216 detects that connectivity with the server device 120 is lost, the monitoring circuitry 216 adds a disconnection entry to the list of disconnection entries and logs the disconnection start time (T_{offline_start}) within that entry to indicate when disconnection is detected. When the monitoring circuitry 216 detects that connectivity with the server device 120 has been re-established, the monitoring circuitry 216 logs the disconnection end time (T_{offline_end}) in that entry. If no disconnection ever occurs between the network device 110 and the server device 120, the list remains empty or the message 140 does not include a list of disconnection entries.

In some embodiments, the processing circuitry 212 includes a processor and memory. The processor operates in accordance with certain locally stored software constructs (e.g., an operating system, control code, etc.) to form specialized equipment that enables the network device 110 to work with the server device 120 to resolve network device serviceability. Such specialized equipment may be implemented in a variety of other ways including via multiple processors (or processing cores) running specialized software, application specific ICs (ASICs), field programmable gate arrays (FPGAs) and associated programs, discrete components, analog circuits, other hardware circuitry, combinations thereof, and so on.

In the context of one or more processors executing locally stored software, a computer program product 230 is capable of delivering all or portions of the software to the network device 110. Along these lines, the computer program product 230 includes a non-transitory computer readable medium which stores a set of instructions that controls one or more operations of the network device 110. Examples of suitable computer readable storage media include tangible articles of manufacture and apparatus which store instructions in a non-volatile manner such as DVD, CD-ROM, flash memory, disk memory, tape memory, and the like.

As shown in FIG. 3, the network device 110 performs a procedure 300 which involves generating and transmitting a message 140 to the server device 120 at a regular interval to enable the server device 120 (FIG. 1) to resolve network device serviceability. The procedure 300 may be performed by the processing circuitry 212 of the serviceability circuitry 210 (FIG. 2) of the network device 110 once the network device 110 becomes serviceable.

At 302, the serviceability circuitry 210 begins tracking time. Along these lines, in response to the network device 110 becoming serviceable, the serviceability circuitry 210 configures the time tracking circuitry 214 to enable indication of an amount of time that elapses while the network device 110 remains serviceable. For example, as mentioned earlier, the serviceability circuitry 210 may start a timer (or counter), may store a starting timestamp in memory that represents a serviceability start time that can be subtracted from the current time, etc. The serviceability circuitry 210 then proceeds from 302 to 304.

At 304, the serviceability circuitry 210 determines whether the network device 110 should send a message 140 to the server device 120. Initially, the serviceability circuitry 210 immediately proceeds from 304 to 306 upon the network device 110 becoming serviceable. However, in subsequent iterations, the serviceability circuitry 210 waits until the end of a regular time interval has been reached before proceeding from 304 to 306. It should be understood that the regular time interval may be a predefined or default amount of time (e.g., 30 minutes, 1 hour, 90 minutes, etc.) which may be adjusted (or tuned) as desired. When the serviceability circuitry 210 determines that the current time interval has ended (or expired) and that it is time to generate and transmit a message 140 to the server device 120, the serviceability circuitry 210 proceeds from 304 to 306.

At 306, the serviceability circuitry 210 ascertains whether the network device 110 is connected (or has connectivity) with the server device 120 through the network. If the network device 110 is able to communicate with the server device 120, the serviceability circuitry 210 proceeds from 306 to 308 to send a message 140 to the server device 120. If the network device 110 is not able to communicate with the server device 120, the serviceability circuitry 210 proceeds from 306 back to 304 to wait until the end of the next regular time interval.

It should be understood that while the serviceability circuitry 210 performs the various activities of the procedure 300, the serviceability circuitry 210 may create and/or update entries within the list of disconnection entries mentioned earlier. As mentioned earlier, the list of disconnection entries identifies a list of time periods when the network device 110 was serviceable but disconnected from the server device 120. In some arrangements, creating and/or updating entries within the list is performed by the monitoring circuitry 216 in the background. In other arrangements, such activity is performed as part of the procedure 300 (e.g., during 304 and 306).

At 308, the serviceability circuitry 210 generates and transmits a message 140 to the server device 120 through the network (also see FIG. 1). The message 140 indicates the amount of time that has elapsed since the network device 110 became serviceable to enable the server device 120 to determine whether the network device 110 has remained serviceable since a previous time when the network device 110 was confirmed to be serviceable. Along these lines, as shown in the earlier-mentioned message format, the message 140 includes serviceability information such as a current timestamp indicating the current time (Timestamp) on the network device 110, an uptime parameter (Uptime) indicating the duration of time over which the network device has remained serviceable, and the list of disconnection entries (Disconnection_List) which identifies disconnection time intervals (e.g., defined by disconnection start and end times) during which the network device 110 could not communicate with the server device 120.

After the serviceability circuitry 210 sends the message 140 to the server device 120, the serviceability circuitry 210 proceeds from 308 back to 304 to perform another iteration of the procedure 300. It should be understood that such operation may continue indefinitely.

It should be further understood that the network device 110 performs the procedure 300 while the network device 110 performs other operations. In the context of a WAP, these operations may include carrying out wireless communications with wireless devices.

### Server Device Details

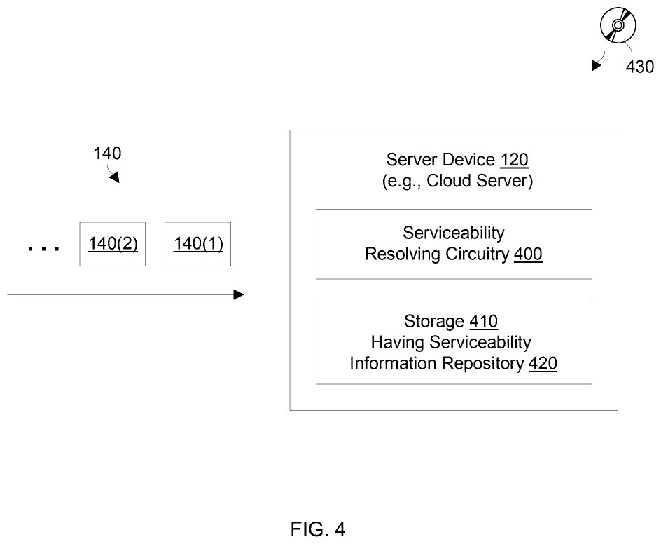

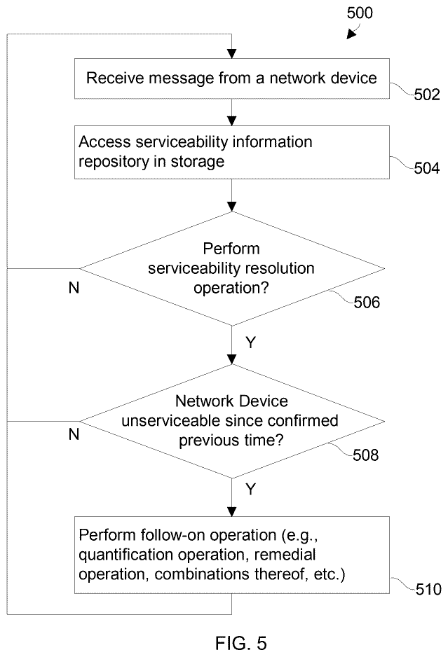

FIGS. 4 and 5 provide certain details for a server device 120 (also see FIG. 1) in accordance with certain embodiments. FIG. 4 shows certain componentry details for the server device 120. FIG. 5 shows a flowchart of a procedure performed by the server device 120.

As shown in FIG. 4, the server device 120 includes serviceability resolving circuitry 400 and storage 410. The serviceability resolving circuitry 400 is constructed and arranged to receive and process messages 140(1), 140(2) . . . from a network device 110 to resolve network device serviceability. The storage 410 includes computerized memory which is constructed and arranged to hold a serviceability information repository 420 containing serviceability information extracted from the messages 140 to enable the serviceability resolving circuitry 400 to resolve network device serviceability based on the serviceability information.

In accordance with certain embodiments, when the serviceability resolving circuitry 400 receives a message 140 from the network device 110, the serviceability resolving circuitry 400 extracts serviceability information from the message 140, and stores that serviceability information within the serviceability information repository 420. After the serviceability resolving circuitry 400 receives two messages 140 from the network device 110 (one message 140 at a previous time and another message at a current time), the serviceability resolving circuitry 400 is able to ascertain whether the network device 110 has remained serviceable since the previous time.

In some arrangements, the serviceability information repository 420 is constructed and arranged to hold the serviceability information of at most two messages 140 to conserve memory resources. Accordingly, when the serviceability resolving circuitry 400 has new serviceability information to store within the serviceability information repository 420 and there is already serviceability information of two messages 140 stored within the serviceability information repository 420, the serviceability resolving circuitry 400 removes the oldest serviceability information from the serviceability information repository 420. The serviceability resolving circuitry 400 then stores the new serviceability information within the serviceability information repository 420 such that the serviceability information repository 420 then holds the serviceability information from the two most recent messages 140 that the server device 120 has received from the network device 110.

An example format for a serviceability information repository 420 that holds the serviceability information from the two most recently received messages 140 is as follows:
Repository:
   {
      ServiceabilityInformation_{current},
      ServiceabilityInformationₚᵣₑᵥᵢₒᵤₛ,
   56
      The serviceability information extracted from the more recently received message 140 is ServiceabilityInformation_{current}. The serviceability information extracted from the older message 140 is ServiceabilityInformationₚᵣₑᵥᵢₒᵤₛ.

It should be understood that other formats are suitable for use by the serviceability information repository 420. For example, in some arrangements, the serviceability information repository 420 holds entire messages 140 received from the network device 110 rather than merely hold the serviceability information extracted from the messages 140. As another example, in some arrangements, the serviceability information repository 420 is expanded to hold more than the two most recently received messages 140 (e.g., three messages 140, four messages 140, etc.), and so on.

It should be understood that the serviceability resolving circuitry 400 may include computerized circuitry such as a processor and memory. Along these lines, the computerized circuitry may operate in accordance with certain software constructs stored within the memory (e.g., an operating system, control code, etc.) to form specialized equipment that enables the server device 120 to resolve network device serviceability. Such specialized equipment may be implemented in a variety of other ways including via multiple processors (or processing cores) running specialized software, application specific ICs (ASICs), field programmable gate arrays (FPGAs) and associated programs, discrete components, analog circuits, other hardware circuitry, combinations thereof, and so on.

In the context of one or more processors executing software, a computer program product 430 is capable of delivering all or portions of the software to the server device 120. Along these lines, the computer program product 430 includes a non-transitory computer readable medium which stores a set of instructions that controls one or more operations of the server device 120. Examples of suitable computer readable storage media include tangible articles of manufacture and apparatus which store instructions in a non-volatile manner such as DVD, CD-ROM, flash memory, disk memory, tape memory, and the like.

As shown in FIG. 5, the server device 120 performs a procedure 500 to resolve network device serviceability. The procedure 500 may be performed by the serviceability resolving circuitry 400 (FIG. 4) of the server device 120 based on messages 140 received from a network device 110 (e.g., also see FIGS. 1 through 3).

At 502, the serviceability resolving circuitry 400 receives a message 140 from a network device 110. As mentioned earlier, such a message 140 includes serviceability information which indicates a duration of time over which the network device 110 has remained serviceable (e.g., see the example format for a message 140 shown earlier). Then, the serviceability resolving circuitry 400 proceeds from 502 to 504.

At 504, the serviceability resolving circuitry 400 accesses the storage 410. Along these lines, if there has been no other message 140 received from the network device 110, the serviceability information repository 420 is currently empty and the serviceability resolving circuitry 400 simply extracts serviceability information from the newly received message 140 and writes the serviceability information into the serviceability information repository 420.

However, if an earlier message 140 had been received from the network device 110, the serviceability resolving circuitry 410 writes the serviceability information into the serviceability information repository 420 as well as reads the serviceability information from the earlier message 140. Along these lines, the serviceability resolving circuitry 410 retrieves a previous timestamp from the serviceability information of the earlier message 140. The previous timestamp indicates a previous time when the network device 110 was confirmed to be serviceable. Next, the serviceability resolving circuitry 410 proceeds from 504 to 506.

At 506, the serviceability resolving circuitry 410 attempts to perform a serviceability resolution operation that provides a serviceability result indicating whether the network device 110 has remained serviceable since the previous time when the network device 110 was confirmed to be serviceable. Along these lines, if the serviceability resolving circuitry 410 was not able to retrieve a previous timestamp from the serviceability information of the earlier message 140, the serviceability resolving circuitry 410 simply proceeds from 506 back to 502 to await receipt of another message from the network device 110.

However, if the serviceability resolving circuitry 410 was able to retrieve a previous timestamp from the serviceability information of the earlier message 140, the serviceability resolving circuitry 410 performs the serviceability resolution operation. Along these lines, the serviceability resolving circuitry 410 applies Equation (1) below:

T_{current}−T_{serviceable}≤Tₚᵣₑᵥᵢₒᵤₛ Equation (1),

where T_{current} is the current time identified by a current timestamp (e.g., Timestamp) extracted from the newly received message 140, T_{serviceable} is the amount of time that has elapsed since the network device 110 became serviceable as identified by an uptime parameter (e.g., Uptime) extracted from the newly received message 140, and Tₚᵣₑᵥᵢₒᵤₛ is the previous time when the network device 110 was confirmed to be serviceable as identified by a previous timestamp (e.g., Timestamp) in the serviceability information of the earlier message 140 stored in the serviceability information repository 420.

Additionally, in the inequality of Equation (1), “≤” means “at or before” in terms of time. Accordingly, the inequality of Equation (1) is true when the left side of Equation (1) (T_{current}−T_{serviceable}) identifies a time that is at or before that of the right side of Equation (1) (Tₚᵣₑᵥᵢₒᵤₛ). Moreover, since time refers to a particular time of day on a particular date, Equation (1) remains appropriate even when T_{serviceable} is greater than 24 hours.

It should be appreciated that, by subtracting T_{serviceable} from T_{current}, the serviceability resolving circuitry 410 essentially generates a start-of-serviceability timestamp which indicates a start-of-serviceability time, i.e., a time when the network device 110 became serviceable. The serviceability resolving circuitry 410 then proceeds from 506 to 508.

At 508, the serviceability resolving circuitry 410 ascertains whether the inequality of Equation (1) is true or false. If the inequality of Equation (1) is true, the network device 110 has remained serviceable since the previous time when the network device 110 was confirmed to be serviceable, and the serviceability resolving circuitry 410 proceeds from 508 back to 502 to repeat the procedure 500 for a next message 140 from the network device 110. However, if the inequality of Equation (1) is false, the network device 110 had become unserviceable since the previous time when the network device 110 was confirmed to be serviceable, and the serviceability resolving circuitry 410 proceeds from 508 to 510.

It should be understood that, for the result of Equation (1) to be false, the network device 110 does not need to be unserviceable for the entire time since the previous time. Rather, the network device 110 may have been unserviceable just briefly (e.g., a few minutes, etc.). Even in a situation in which the network device 110 was unserviceable for a brief time, the result of Equation (1) would be false causing the serviceability resolving circuitry 410 to proceed from 508 to 510.

At 510, the serviceability resolving circuitry 410 performs a follow-on operation such as quantifying how long the network device 110 was unserviceable since the previous time when the network device 110 was confirmed to be serviceable. Such quantification enables an operator to discern whether the network device 110 was momentarily unserviceable or unserviceable for an extended amount of time.

For example, suppose that a coincidental network outage lasted for over an hour, but that the quantification operation indicates that the network device 110 was unserviceable for only a few minutes. In such a situation, it may be unlikely that the network outage was caused by the network device 110 becoming unserviceable for just the few minutes. Instead, the unserviceability occurrence by the network device 110 may have been merely by chance.

In some arrangements, the serviceability resolving circuitry 410 tallies the amount of time that the network device 110 was serviceable but disconnected from the server device 120 based on the list of disconnection entries (e.g., Disconnection_List). Here, the serviceability resolving circuitry 410 may then make certain adjustments/corrections/etc. to make sure such disconnection time is not inappropriately considered unserviceable time. Further details as to how such tallying/adjusting may take place will be provided shortly in the form of timeline examples.

Additionally or alternatively, the follow-on operation may include remedial activity. For example, the serviceability resolving circuitry 410 may add an entry to an event log, may provide an alert to a user (or operator), may perform a reconfiguration (or failover) operation which modifies how the network device 110 and/or other equipment within the network operates, combinations thereof, etc. The extent of the remedial activity may depend on whether the network device 110 was expected to be unserviceable, the type of equipment, whether there is redundancy, combinations thereof, and so on.

Upon completion of the follow-on operation, the serviceability resolving circuitry 410 proceeds from 510 back to 502 to perform another iteration of the procedure 500 for a next incoming message 140 from the network device 110. Such operation may continue indefinitely.

At this point, it should be appreciated that the procedure 500 enables the server device 120 to avoid an incorrect conclusion regarding the network device 110. For example, in the context of a WAP, the network device 110 may be able to continue servicing Wi-Fi clients even while the network device 110 has lost connectivity with the server device 120. In such a situation, when connectivity is re-established between the network device 110 and the server device 120, the server device 120 may be able to ascertain that the network device 110 remained operational while connectivity between the network device 110 and the server device 120 was lost. Accordingly, effort to identify/address the loss in connectivity may be refocused in other directions (e.g., perhaps to discover that the loss in connectivity was due to an unrelated network event such as a temporary and unrelated misconfiguration of a firewall, etc.). As a result, such resolution of network device serviceability avoids a misdiagnosis which could have otherwise led to inappropriate failover/reconfiguration activities, extended network downtime/delays, unnecessary equipment replacement work, continuing problems, and so on.

It should be further appreciated that the server device 120 may perform the procedure 500 for multiple network devices 110 concurrently. For example, for the network devices 110 in FIG. 1, the server device 120 may run a first instance of the procedure 500 for the network device 110(1), a second instance of the procedure 500 for the network device 110(2), and so on.

Moreover, the server device 120 that performs the procedure 500 for a first network device 110 may be a second network device 110. Similarly, the server device 120 that performs the procedure 500 for the second network device 110 and/or for a third network device 110 may be a fourth network device 110 or equipment which is not a network device, and so on.

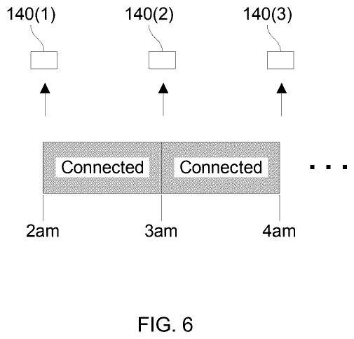

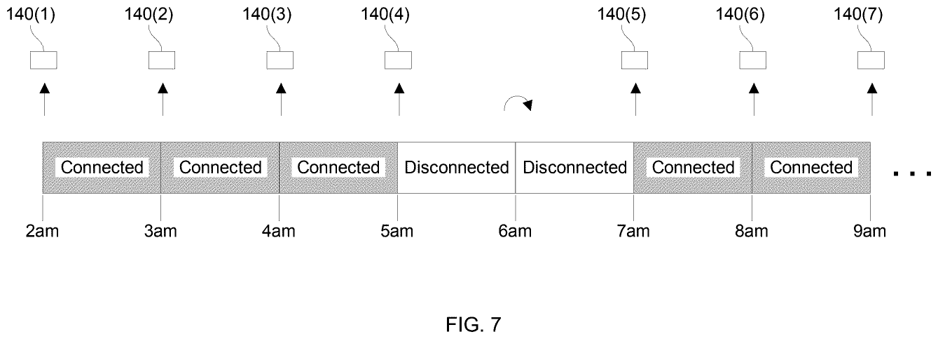

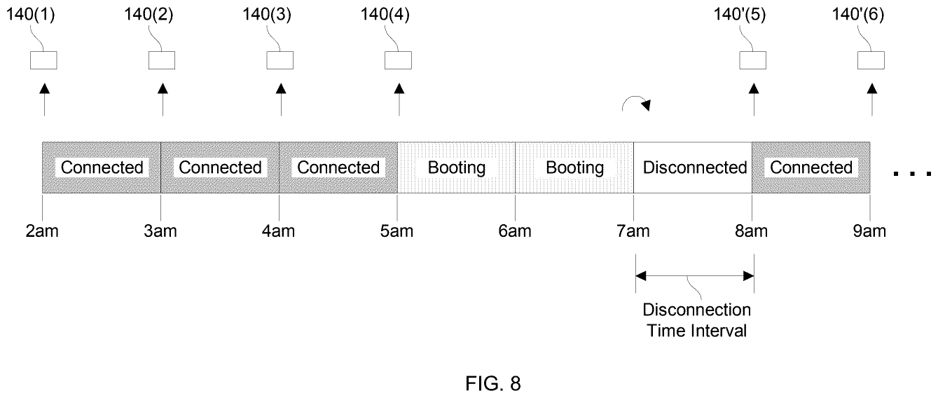

FIGS. 6 through 13 provide example timelines of network device operating status from which the server device 120 is able to resolve/discern network device serviceability in accordance with one or more embodiments. For FIGS. 6 and 7, the server device 120 determines whether the network device 110 remained serviceable during the example timelines. For FIGS. 8 through 13, after the server device 120 has concluded that the network device 110 had become unserviceable for some amount of time, the server device 120 derives the amount of time that the network device 110 was unserviceable.

### Example 1

FIG. 6 is a first example timeline during which the network device 110 remains serviceable throughout, and during which the network device 110 and the server device 120 are never disconnected. Since the network device 110 remains serviceable, the inequality of Equation (1) (provided earlier) is always true, as will now be explained in further detail.

Along these lines, suppose that a network device 110 is configured to send a message 140 to the server device 120 every hour (also see the network device 110(1) and the server device 120 in FIG. 1). Furthermore and with reference to Equation (1) suppose that T_{current} (the current time) is 2 am, and that network device 110 has just become serviceable and has just begun tracking T_{serviceable} (the duration of time over which the network device 110 has remained serviceable). Along these lines, the network device 110 may have just finished booting and now starts tracking the duration of time over which the network device 110 remains serviceable (e.g., starting a timer, by storing a timestamp, etc.).

At 2 am, the network device 110 sends a first message 140(1) containing serviceability information to the server device 120 (also see the example format for a message 140 shown earlier). The serviceability information within the message 140(1) includes a timestamp which indicates 2 am as T_{current}, and an uptime parameter which indicates 0 hours (or minutes) as T_{serviceable}. Concurrently, the network device 110 may perform various networking operations (e.g., by operating as a WAP) since the network device 110 is currently serviceable.

As time progresses, suppose that the network device 110 remains serviceable (e.g., remains available to perform WAP operations). Further suppose that the network device 110 remains connected with the server device 120 (e.g., the network device 110 and the server device 120 maintain the ability to communicate with each other).

At 3 am (after an hour has passed since the network device 110 sent the first message 140(1)), the network device 110 sends a second message 140(2) to the server device 120. The serviceability information within the message 140(2) includes a timestamp which indicates 3 am as T_{current}, and an uptime parameter which indicates 1 hour (or 60 minutes) as T_{serviceable}. Again, during this time, the network device 110 is still available to perform various network operations, and is still connected with the server device 120.

Similarly, at 4 am, the network device 110(1) sends another message 140(3) to the server device 120. The serviceability information within the message 140(3) includes a timestamp which indicates 4 am as T_{current}, and an uptime parameter which indicates 2 hours (or 120 minutes) as T_{serviceable}. Again, during this time, the network device 110 is still available to perform various network operations. It should be understood that such operation by the network device 110 may continue in this manner over time.

As the server device 120 receives the messages 140 from the network device 110, the server device 120 resolves network device serviceability based on the serviceability information within the messages 140 (also see FIGS. 4 and 5). Along these lines, the server device 120 applies Equation (1) to determine whether the network device 110 has remained serviceable since a previous time when the network device 110 was confirmed to be serviceable. Recall that, if the inequality of Equation (1) is true, the network device 110 became serviceable (e.g., booted up and became available to perform operations) at or before the previous time when the network device 110 was confirmed to be serviceable, Tₚᵣₑᵥᵢₒᵤₛ. However, if the inequality of Equation (1) is false, the network device 110 became unserviceable at some time after Tₚᵣₑᵥᵢₒᵤₛ.

In the example of FIG. 6, when the server device 120 receives the message 140(1) from the network device 110 at 2 am, the server device 120 extracts and saves the serviceability information from the first message 140(1) into storage. Recall that the timestamp of the serviceability information within the first message 140(1) indicates 2 am as T_{current}.

When the server device 120 later receives the second message 140(2) from the network device 110 at 3 am, the server device 120 again extracts and saves the serviceability information from the message 140(2) into storage. Recall that the timestamp of the serviceability information within the second message 140(2) indicates 3 am as T_{current} and 1 hour as T_{serviceable}. Accordingly, the timestamp of the now older serviceability information within the first message 140(1), which is 2 am, is now considered Tₚᵣₑᵥᵢₒᵤₛ.

Additionally, now that there is serviceability information from two messages 140 in storage, the server device 120 performs a serviceability resolution operation by applying Equation (1) to generate a serviceability result (true or false) indicating whether the network device 110 has remained serviceable since Tₚᵣₑᵥᵢₒᵤₛ.

To this end and as shown by the left side of Equation (1) above, the server device 120 calculates a start-of-serviceability timestamp which indicates the time when the network device 110 became serviceable based on T_{current} and T_{serviceable}. Along these lines, if the T_{current} is 3 am and T_{serviceable} is 1 hour, the server device 120 ascertains that the network device 110 became serviceable at 2 am (i.e., 3 am minus 1 hour). As for the right side of Equation (1), Tₚᵣₑᵥᵢₒᵤₛ is 2 am.

Since the computed time when the network device 110 became serviceable is also 2 am, the inequality of Equation (1) is true so the server device 120 concludes that the network device 110 has remained serviceable since the previous time when the network device 110 was confirmed to be serviceable. Accordingly, no follow-on operation is needed, and the server device 120 may simply wait for another message 140 from the network device 110 (e.g., 508 proceeds back to 502 in FIG. 5).

Later, when the server device 120 receives the third message 140(3) from the network device 110 at 4 am, the server device 120 again extracts and saves the serviceability information from the message 140(3) into storage. Recall that the timestamp of the serviceability information within the third message 140(3) indicates 4 am as T_{current} and 2 hours as T_{serviceable}. In accordance with one or more embodiments, the server device 120 simply holds serviceability information from the two most recently received messages 140 so the serviceability information from the second message 140(2) is kept but the serviceability information from the first message 140(1) is discarded. Accordingly, the timestamp of the now older serviceability information within the second message 140(2), which is 3 am, is now considered Tₚᵣₑᵥᵢₒᵤₛ.

The server device 120 then performs a serviceability resolution operation by applying Equation (1) to generate another serviceability result indicating whether the network device 110 has remained serviceable since Tₚᵣₑᵥᵢₒᵤₛ. To this end again applies Equation (1). Along these lines, for the left side of Equation (1), if the T_{current} is 4 am and T_{serviceable} is 2 hours, the server device 120 ascertains that the network device 110 became serviceable at 2 am (i.e., 4 am minus 2 hours). As for the right side of Equation (1), Tₚᵣₑᵥᵢₒᵤₛ is 3 am.

Since the computed time when the network device 110 became serviceable is 2 am which is before 3 am, the inequality of Equation (1) is true so the server device 120 again concludes that the network device 110 has remained serviceable since the previous time when the network device 110 was confirmed to be serviceable. As a result, no follow-on operation is needed, and the server device 120 may simply wait for another message 140 from the network device 110 (e.g., 508 again proceeds back to 502 in FIG. 5).

As explained above, since the network device 110 remains serviceable throughout, the inequality of Equation (1) is always true. It should be understood that such operation by the server device 120 may continue as the server device 120 receives and processes new messages 140 from the network device 110. It should be further understood that the server device 120 may perform the above-described operations for multiple network devices 110 over time.

It should be further understood that, since the network device 110 and the server device 120 were never disconnected, there were no disconnection time intervals detected by the network device 110 (e.g., also see the monitoring circuitry 216 in FIG. 2). Accordingly, within the messages 140 sent from the network device 110 to the server device 120, the list of disconnection entries identifying disconnection time intervals is either empty or not included in the messages 140.

### Example 2

FIG. 7 is a second example timeline during which (i) the network device 110 remains serviceable throughout, and (ii) the network device 110 and the server device 120 are disconnected for some length (or interval) of time. Nevertheless, since the network device 110 remains serviceable throughout, the inequality of Equation (1) is always true, as will now be explained in further detail.

Along these lines, suppose that the network device 110 operates normally (e.g., performing networking operations) and communicates with the server device 120 at routine intervals as described in Example 1 above. For this period of operation, the explanation provided above for Example 1 applies to this example as well and thus will not be repeated.

However, suppose that the network device 110 then becomes disconnected from the server device 120. In particular, suppose that the network device 110 and the server device 120 are disconnected from just after 5 am to just before 7 am.

During this time of disconnection, suppose that the network device 110 remains serviceable, but that the network device 110 is simply unable to communicate with the server device 120. For example, a network event may have occurred within the communications medium 130 (also see FIG. 1) such as a node failure or misconfiguration that prevents the server device 120 from receiving communications from the network device 110 until the network event is resolved.

At 5 am, just prior to the network event, suppose that the network device 110 sends a message 140(4) to the server device 120. Within the message 140(4), the serviceability information includes a current timestamp which indicates 5 am as T_{current} (the current time), and 3 hours as T_{serviceable} (the duration of time over which the network device 110 has remained serviceable).

Upon receipt of the message 140(4), the server device 120 stores the serviceability information of the message 140(4) and applies Equation (1) to resolve serviceability of the network device 110. Along these lines, the server device 120 calculates the time when the network device 110 became serviceable based on T_{current} and T_{serviceable}. Along these lines, if T_{current} is 5 am and T_{serviceable} is 3 hours, the server device 120 ascertains that the network device 110 became serviceable at 2 am (i.e., 5 am minus 3 hours).

The server device 120 then compares the computed time of 2 am with Tₚᵣₑᵥᵢₒᵤₛ, i.e., the time when the network device 110 was confirmed to be serviceable as indicated by a stored timestamp of the message 140(3) which indicates that the network device 110 was serviceable at 4 am. Since 2 am is before 4 am, the inequality of Equation (1) is true. Accordingly, the service device 120 concludes that the network device 110 has remained serviceable since 4 am and considers the network device 110 to have been serviceable at 5 am. As a result, no follow-on operation is needed, and the server device 120 may simply wait for another message 140 from the network device 110 (e.g., 508 proceeds back to 502 in FIG. 5).

At 6 am, during the time of disconnection, the network device 110 may attempt to convey a message 140 to the server device 120 (illustrated by the curved arrow in FIG. 7). However, since the network device 110 determines that it is unable to communicate with the server device 120, the network device 110 does not send the message 140 (306 proceeds back to 304 in FIG. 3).

It should be understood that, if the network device 110 had been able to send a message 140 to the server device 120, the serviceability information within the message 140 would have included a current timestamp indicating 6 am as T_{current}, and an uptime parameter indicating 4 hours as T_{serviceable}.

At 7 am, just after connection between the network device 110 and the server device 120 is re-established, the network device 110 sends a message 140(5) to the server device 120. Within the message 140(5), the serviceability information includes a current timestamp which indicates 7 am as T_{current}, and an uptime parameter which indicates 5 hours as T_{serviceable}.

Upon receipt of the message 140(5), the server device 120 stores the serviceability information of the message 140(5) and applies Equation (1) to resolve serviceability of the network device 110. Along these lines, the server device 120 calculates the time when the network device 110 became serviceable based on T_{current} and T_{serviceable}. Along these lines, since T_{current} is 7 am and T_{serviceable} is 5 hours, the server device 120 ascertains that the network device 110 became serviceable at 2 am (i.e., 7 am minus 5 hours).

The server device 120 then compares the computed time when the network device 110 became serviceable with Tₚᵣₑᵥᵢₒᵤₛ. Recall that the message 140(4) was sent by the network device 110 to the server device 120 at 5 am before being received and processed by the server device 120. Further recall that the network device 110 did not send a message 140 to the server device 120 at 6 am due to the network event. Accordingly, Tₚᵣₑᵥᵢₒᵤₛ is 5 am.

Since the server device 120 determines that the network device 110 became serviceable at 2 am which is before Tₚᵣₑᵥᵢₒᵤₛ, the inequality of Equation (1) is true. Accordingly, the service device 120 concludes that the network device 110 has remained serviceable since 5 am. As a result, no follow-on operation is needed, and the server device 120 may simply wait for another message 140 from the network device 110 (e.g., 508 proceeds back to 502 in FIG. 5).

At this point, it should be appreciated that even when there is a network event that prevents the network device 110 from communicating with the server device 120, the server device 120 is still able to ascertain whether the network device 110 remained serviceable since the previous time when the network device 110 was confirmed to be serviceable. In this case, the server device 120 determined that the network device 110 remained serviceable during the time of disconnection caused by the network event.

Once communications between the network device 110 and the server device 120 are re-established, the server device 120 is further able to resolve network device serviceability in response to subsequent messages 140(6), 140(7), . . . from the network device 110 as well. Along these lines, the network device 110 sends a new message 140(6) at 8 am and the server device 120 resolves network device serviceability in response to the message 140(6). Additionally, the network device 110 sends a new message 140(7) at 9 am and the server device 120 resolves network device serviceability in response to the message 140(7), and so on.

It should be further understood that, since the network device 110 and the server device 120 were disconnected for a period of time, the network device 110 included a list of disconnection entries containing an entry within the message 140(5) (e.g., also see the earlier-provided format for a message 140). The entry (e.g., added by the monitoring circuitry 216, also see FIG. 2) identified a time interval of just after 5 am to just before 7 am. However, in the subsequent messages 140(6) and 140(7), there were no such entries because there were no further disconnections. Certain use cases for the list of disconnection entries will be provided shortly.

### Example 3

FIG. 8 is a third example timeline during which the network device 110 is unserviceable for a period of time, followed by a period of time in which the network device 110 is serviceable but unable to communicate with the server device 120, followed by another period of time in which the network device 110 and the server device 120 are able to communicate with each other again. In this situation, since the network device 110 did not remain serviceable throughout, the inequality of Equation (1) becomes false at some point, as will now be explained in further detail.

First, suppose that the network device 110 operates normally (e.g., performing networking operations) and communicates with the server device 120 at routine intervals as described in Example 1 above. For this period of operation, the explanation provided above for Example 1 applies to this example as well and thus will not be repeated.

However, suppose that the network device 110 becomes unserviceable from just after 5 am until 7 am (e.g., the network device 110 may have been in the process of booting during this period of time). Further suppose that immediately after the network device 110 becomes serviceable again at 7 am, there is a network event which prevents the network device 110 and the server device 120 from communicating from 7 am to just before 8 am, before connectivity between the network device 110 and the server device 120 is re-established.

At 5 am, just before the network device 110 becomes unserviceable, suppose that the network device 110 sends a message 140(4) to the server device 120. Within the message 140(4), the serviceability information includes a current timestamp which indicates 5 am as T_{current}, and 3 hours as T_{serviceable}.

Upon receipt of the message 140(4), the server device 120 stores the serviceability information of the message 140(4) and applies Equation (1) to resolve serviceability of the network device 110. Along these lines, the server device 120 calculates the time when the network device 110 became serviceable based on T_{current} and T_{serviceable}. Along these lines, since T_{current} is 5 am and T_{serviceable} is 3 hours, the server device 120 ascertains that the network device 110 became serviceable at 2 am (i.e., 5 am minus 3 hours).

The server device 120 then compares the computed time of 2 am with Tₚᵣₑᵥᵢₒᵤₛ, i.e., the time when the network device 110 was confirmed to be serviceable as indicated by a stored timestamp of the message 140(3) which indicates that the network device 110 was serviceable at 4 am. Since 2 am is before 4 am, the inequality of Equation (1) is true. Accordingly, the service device 120 concludes that the network device 110 has remained serviceable since 4 am and considers the network device 110 to have been serviceable at 5 am. As a result, no follow-on operation is needed, and the server device 120 may simply wait for another message 140 from the network device 110 (e.g., 508 proceeds back to 502 in FIG. 5).

From just after 5 am to 7 am, the network device 110 is unserviceable because the network device 110 is booting. Accordingly, there are no attempts by the network device 110 to convey a message 140 to the server device 120 during this period of time.

At 7 am, the network device 110 becomes serviceable again. Along these lines, the network device 110 has just finished booting. Accordingly, the network device 110 attempts to convey a message 140 to the server device 120. However, since the network device 110 determines that it is unable to communicate with the server device 120, the network device 110 does not send the message 140 (e.g., 306 proceeds to 304 in FIG. 3). Also at this time, the network device 110 may create an entry within the list of disconnection entries (Disconnection_List) to identify a disconnection time interval.

It should be understood that, if the network device 110 had been able to send a message 140 to the server device 120, the serviceability information within the message 140 would have included a current timestamp indicating 7 am as T_{current}, and an uptime parameter indicating 0 hours (or minutes) as T_{serviceable} since the network device 110 just became serviceable.

At 8 am, just after communications between the network device 110 and the server device 120 are re-established, the network device 110 sends a message 140′(5) to the server device 120. Within the message 140′(5), the serviceability information includes a current timestamp which indicates 8 am as T_{current}, and an uptime parameter which indicates 1 hour as T_{serviceable} since the network device 110 became serviceable at 7 am.

Upon receipt of the message 140′(5), the server device 120 stores the serviceability information of the message 140′(5) and applies Equation (1) to resolve serviceability of the network device 110. Along these lines, the server device 120 calculates the time when the network device 110 became serviceable based on T_{current} and T_{serviceable}. In particular, since T_{current} is 8 am and T_{serviceable} is 1 hour, the server device 120 ascertains that the network device 110 became serviceable at 7 am (i.e., 8 am minus 1 hour).

The server device 120 then compares the computed time of 7 am with Tₚᵣₑᵥᵢₒᵤₛ, i.e., the time when the network device 110 was confirmed to be serviceable as indicated by a stored timestamp of the message 140(4) which indicates that the network device 110 was serviceable at 5 am. Since 7 am is after 5 am, the inequality of Equation (1) is false. Accordingly, the service device 120 concludes that the network device 110 was unserviceable for at least a brief time since 5 am. As a result, the server device 120 performs a follow-on operation in response to detection that the network device 110 was unserviceable, at least briefly, since Tₚᵣₑᵥᵢₒᵤₛ (e.g., 508 proceeds to 510 in FIG. 5).

In accordance with certain embodiments, the follow-on operation involves quantifying the amount of time that the network device 110 was unserviceable. For such a quantification operation, the server device 120 performs the operation of Equation (2) below:

T_{unserviceable}=T_{current}−Tₚᵣₑᵥᵢₒᵤₛ−(T_{interval_1}+T_{interval_2}+. . . ) Equation (2),

Here, T_{unserviceable} is the total amount of time that the network device 110 was unserviceable.

Additionally, if there is a list of disconnection entries (Disconnection_List) within the current message 140, T_{interval_1} is a time interval (or length of time) identified by a first entry in the list of disconnection entries, T_{interval_2} is a time interval identified by a second entry in the list of disconnection entries (if it exists), and so on. Recall, that each time interval may be defined by time interval endpoints (T_{offline_start_k} and T_{offline_end_k}). Such time intervals may be subtracted (i.e., used for adjustment) to prevent T_{unserviceable} from including time during which the network device 110 was serviceable but disconnected from the server device 120.

In the application of Equation (2), T_{current}−Tₚᵣₑᵥᵢₒᵤₛ is the length of time between when the server device 120 received the current message 140 and the previous message 140. In this example, since T_{current} is 8 am and Tₚᵣₑᵥᵢₒᵤₛ is 5 am, the length of time between when the server device 120 received the current message 140 and the previous message 140 is 3 hours.

Next, if there is a list of disconnection entries, any disconnection time intervals identified by the list of disconnection entries is then subtracted. In this example, the list of disconnection entries includes an entry which identifies a disconnection time interval spanning from 7 am to 8 am (1 hour). Accordingly, the disconnection time interval (1 hour) is subtracted from the length of time between when the server device 120 received the current message 140 and the previous message 140 (3 hours) resulting in a total amount of unserviceable time of 2 hours. That is, T_{unserviceable} is 2 hours which is shown by the booting time from 5 am to 7 am in FIG. 8.

It should be understood that, at 9 am, the network device 110 sends another message 140′(6) having serviceability information which includes a current timestamp which indicates 9 am as T_{current}, and an uptime parameter which indicates 2 hours as T_{serviceable} since the network device 110 became serviceable at 7 am.

Upon receipt of the message 140′(6), the server device 120 stores the serviceability information of the message 140′(6) and applies Equation (1) to resolve serviceability of the network device 110. Along these lines, the server device 120 calculates the time when the network device 110 became serviceable based on T_{current} and T_{serviceable}. In particular, since T_{current} is 9 am and T_{serviceable} is 2 hours, the server device 120 ascertains that the network device 110 became serviceable at 7 am (i.e., 9 am minus 2 hours).

The server device 120 then applies Equation (1) in which Tₚᵣₑᵥᵢₒᵤₛ is 8 am. Since 7 am is before 8 am, Equation (1) is true. Accordingly, at 9 am and in response to the message 140′(6), the server device 120 concludes that the network device 110 has remained serviceable since 8 am.

### Additional Examples

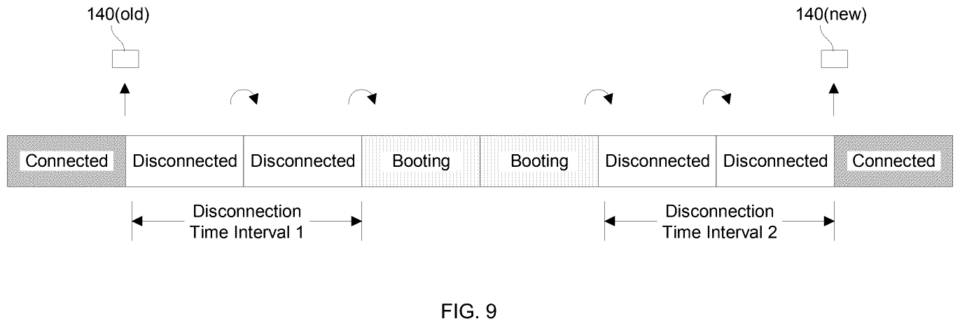

FIGS. 9 through 13 provide additional timeline examples which can be evaluated by Equations (1) and (2) above to resolve network device serviceability. For these additional timeline examples, Equation (1) is false (because the network device 110 became unserviceable at some point) and Equation (2) effectively enables quantification of the length of time that the network device 110 was unserviceable.

FIG. 9 shows an example timeline during which the network device 110 is serviceable, is serviceable but disconnected from the server device 120, is booting, is again serviceable but disconnected from the server device 120, and is serviceable and re-connected with the server device 120. In particular, shortly after the network device 110 conveys the message 140(old) to the server device 120, connectivity between the network device 110 and the server device 120 is lost (disconnection time interval 1). Next, although connectivity between network device 110 and the server device 120 is regained, the network device 110 boots. Then, once the network device 110 becomes serviceable again, connectivity between the network device 110 and the server device 120 is lost a second time (disconnection time interval 2). Finally, connectivity between network device 110 and the server device 120 is regained and the network device 110 conveys a new message 140(new) to the server device 120.

Upon receipt of the message 140(new) from the network device 110, the server device 120 applies Equation (2) provided above to compute the amount of time that the network device 110 was unserviceable. Such application of Equation (2) results in the following:

T_{unserviceable}=T_{current}−Tₚᵣₑᵥᵢₒᵤₛ−T_{interval_1}−T_{interval_2}

where T_{unserviceable} is the computed amount of unserviceable time, T_{interval_1} is the first disconnection time interval (disconnection time interval_1), and T_{interval_2} is the second disconnection time interval (disconnection time interval_2). Recall, that in the list of disconnection entries, a disconnection time interval may be defined by an entry having interval endpoints such as <T_{offline_start}, T_{offline_end}>.

As shown by the multiple disconnection time intervals in FIG. 9, the list of disconnection entries would include multiple entries defining the multiple time intervals during which connectivity between the network device 110 and the server device 120 is lost. Nevertheless, for the example of FIG. 9, Equation (2) is suitable for computing the duration of time over which the network device 110 was unserviceable.

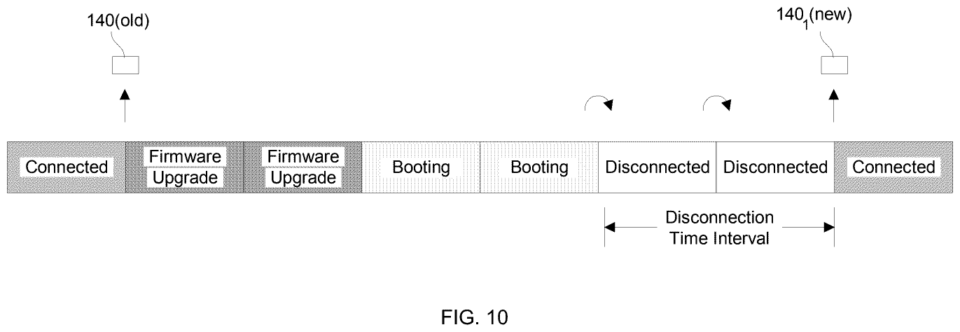

FIG. 10 shows an example timeline which is similar to the example timeline of FIG. 9 except that the example timeline of FIG. 10 includes a period of time during which the firmware on the network device 110 is updated instead of the first disconnection time interval. Along these lines, after the network device 110 is serviceable for some time and sends a message 140(old) to the server device 120, the network device 110 undergoes a firmware update. Upon completion of the firmware update, the network device 110 boots. Once booting is complete, the network device 110 becomes serviceable but the network device 110 is disconnected from the server device 120. Then, once connection between the network device 110 and the server device 120 is re-established, the network device 110 sends a message 140₁(new) to the server device 120.

Upon receipt of the message 140₁(new) from the network device 110, the server device 120 applies Equation (2) to compute the amount of time that the network device 110 was unserviceable. Such application of Equation (2) again results in the following:

T_{unserviceable}=T_{current}−Tₚᵣₑᵥᵢₒᵤₛ−Tᵢₙₜₑᵣᵥₐₗ

where T_{unserviceable} is the computed amount of unserviceable time. Accordingly, for the example of FIG. 10, Equation (2) is suitable for computing the duration of time over which the network device 110 was unserviceable.

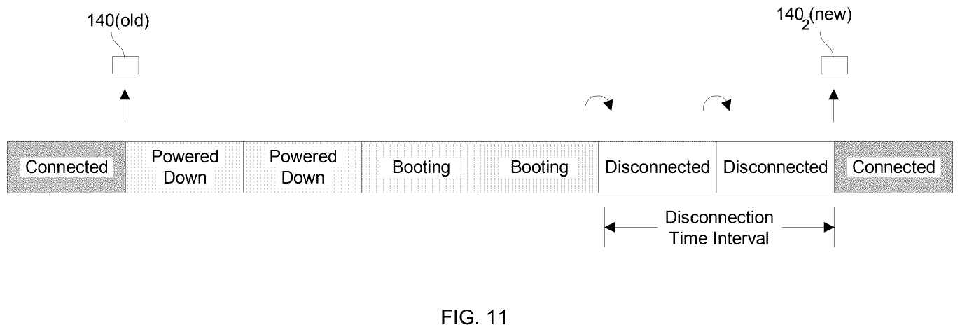

FIG. 11 shows an example timeline which is similar to the example timeline of FIG. 10 except that the example timeline of FIG. 11 includes a period of time during which the network device 110 is powered down instead of undergoing a firmware update. Along these lines, after the network device 110 has been serviceable for a period of time and sends a message 140(old) to the server device 120, the network device 110 is turned off (or loses power). Later, when the network device 110 is turned back on (or regains power), the network device 110 boots. Once booting is complete, the network device 110 is disconnected from the server device 120. Then, once connection between the network device 110 and the server device 120 is re-established, the network device 110 sends a message 140₂(new) to the server device 120.

Upon receipt of the message 140₂(new) from the network device 110, the server device 120 applies Equation (2) to compute the amount of time that the network device 110 was unserviceable. Such application of Equation (2) again results in the following:

T_{unserviceable}=T_{current}−Tₚᵣₑᵥᵢₒᵤₛ−Tᵢₙₜₑᵣᵥₐₗ

where T_{unserviceable} is the computed amount of unserviceable time. Accordingly, Equation (2) is suitable for computing the length of time that the network device 110 was unserviceable.

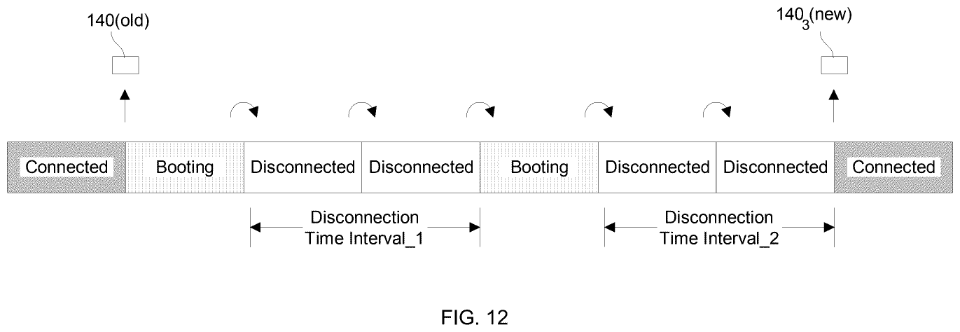

FIG. 12 shows an example timeline which is similar to the example timeline of FIG. 9 except that the example timeline of FIG. 12 also includes a time of booting prior to the first disconnection time interval. In particular, shortly after the network device 110 sends the message 140(old) to the server device 120, the network device 110 boots. Once the network device 110 completes booting and becomes serviceable, the network device 110 is disconnected from the server device 120 (disconnection time interval_1). Then, once connection between the network device 110 and the server device 120 is re-established, the network device 110 boots again. Then, once the network device 110 completes booting and becomes serviceable again, the network device 110 is disconnected from the server device 120 again (disconnection time interval_2). Thereafter, once connection between the network device 110 and the server device 120 is re-established, the network device 110 sends a message 140₃(new) to the server device 120.

Upon receipt of the message 140₃(new) from the network device 110, the server device 120 applies Equation (2) provided above to compute the amount of time that the network device 110 was unserviceable. Such application of Equation (2) results in the following:

T_{unserviceable}=T_{current}−Tₚᵣₑᵥᵢₒᵤₛ−T_{interval_1}−T_{interval_2}

where T_{unserviceable} is the computed amount of unserviceable time, T_{interval_1} is the first disconnection time interval (disconnection time interval_1), and T_{interval_2} is the second disconnection time interval (disconnection time interval_2). Here, as well as in the example of FIG. 9, the list of disconnection entries includes multiple entries defining multiple time intervals during which connectivity between the network device 110 and the server device 120 is lost.

It should be understood that, while the network device 110 is serviceable, additional disconnection time intervals may occur as well. If other disconnection time intervals occurred while the network device 110 is serviceable, those disconnection time intervals are also subtracted when computing the amount of unserviceable time for the network device 110. Accordingly, Equation (2) is suitable for computing the amount of time that the network device 110 was unserviceable.

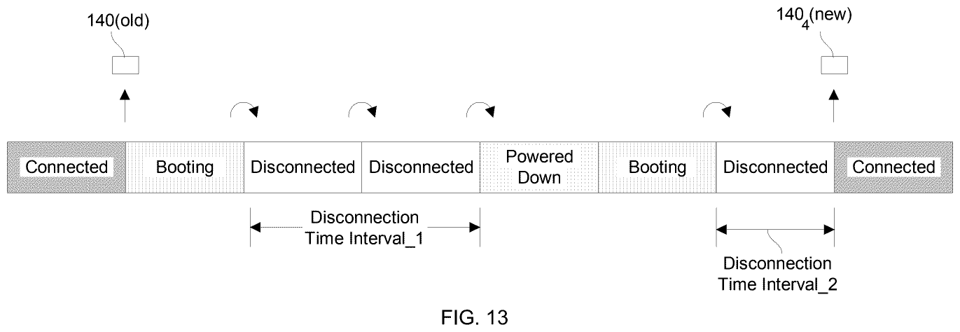

FIG. 13 shows an example timeline which is similar to the example timeline of FIG. 12 except the example timeline of FIG. 13 also includes a time when the network device 110 is powered down prior to rebooting the second time. In particular, shortly after the network device 110 sends the message 140(old) to the server device 120, the network device 110 boots. Once the network device 110 completes booting and becomes serviceable, the network device 110 is disconnected from the server device 120 (disconnection interval_1). Then, once connection between the network device 110 and the server device 120 is re-established, the network device 110 is turned off (or loses power). Then, the network device 110 is turned on again (or regains power) and boots again. Subsequently, the network device 110 completes booting and becomes serviceable again, and the network device 110 is disconnected from the server device 120 again (disconnection interval_2). Thereafter, once connection between the network device 110 and the server device 120 is re-established, the network device 110 sends a message 140₄(new) to the server device 120.

Upon receipt of the message 140₄(new) from the network device 110, the server device 120 applies Equation (2) provided above to compute the amount of time that the network device 110 was unserviceable. Such application of Equation (2) results in the following:

T_{unserviceable}=T_{current}−Tₚᵣₑᵥᵢₒᵤₛ−T_{interval_1}−T_{interval_2}

where T_{unserviceable} is the computed amount of unserviceable time, T_{interval_1} is the first disconnection time interval (disconnection interval_1), and T_{interval_2} is the second disconnection time interval (disconnection interval_2). Again, Equation (2) is suitable for computing the amount of time that the network device 110 was unserviceable.

It should be understood that, even though the network device 110 was powered down between sending the messages 140(old) and 140₄(new), the network device 110 preserved the disconnection interval information for the list of disconnection entries for the message 140₄(new). Along these lines, the storage that the network device 110 uses to maintain the list of disconnection entries is non-volatile memory thus persisting the time interval information even if the network device 110 is powered down.

It should be understood that other combinations of events and situations may occur for the network device 110. For such events/situations, the server device 120 is able to apply Equation (2) to derive the amount of time that the network device 110 was unserviceable.

### Further Details

It should be understood that the server device 120 may resolve network device serviceability for multiple network devices 110 simultaneously. Along these lines and with reference back to FIG. 1, while the server device 120 resolves serviceability for the network device 110(1), the server device 120 similarly may resolve serviceability for the network device 110(2), and for the network device 110(3), and so on.

Furthermore, it should be understood that the messaging periodicity may be the same or different among the networking devices 110. For example, the network device 110(1) may send messages 140 to the server device 120 at 60 minute intervals, the network device 110(2) may send messages 140 to the server device 120 also at 60 minute intervals or at 90 minute intervals, the network device 110(3) may send messages 140 to the server device 120 at 60 minute intervals, at 90 minute intervals, or at 120 minute intervals, and so on.

In some embodiments, the network devices 110 are able to send messages 140 to the server device 120 without messaging periodicity. Along these lines, the server device 120 is nevertheless able to apply Equations (1) and (2) to resolve network device serviceability. For example, the network devices 110 may provide messages 140 to the server device 120 based on certain events such as when network traffic and/or network device load crosses a certain threshold, and so on.

Moreover, it should be understood that the messaging interval may be changed over time for a network device 110. For example, the network device 110 may provide messages 140 to the server device 120 at a first routine interval (e.g., 60 minutes) for an initial period of time, and then switch to providing messages 140 to the server device 120 at a second routine interval (e.g., 90 minutes) for a subsequent period of time, and perhaps switch back or to another interval, and so on.

As described above, various techniques disclosed herein are able to resolve network device serviceability when it appears that a network device 110 may have been unserviceable or unavailable for an amount of time before communication with the network device 110 is re-established. Along these lines, the network device 110 may provide a transmission that includes an uptime value indicating a duration of time over which the network device 110 has remained serviceable. Using this uptime value and a timestamp that indicates a previous time when the network device 100 was confirmed to be serviceable, a serviceability resolution operation may be performed. Such an operation may provide a serviceability result that indicates whether the network device 110 has remained serviceable since the previous time when the network device 110 was confirmed to be serviceable. If the network device 110 has remained serviceable since the previous time, it is possible that another network issue may have contributed to the appearance that the network device was unserviceable.

While various embodiments of the present disclosure have been particularly shown and described, it will be understood by those skilled in the art that various changes in form and details may be made therein without departing from the spirit and scope of the present disclosure. Such modifications and enhancements are intended to belong to various embodiments of the disclosure.

Along these lines, such a network device 110 was described above as operating as a WAP by way of example only. Along these lines, the network device 110 may convey communications among wireless devices which are within range, may communicate with other network devices 110, and so on. However, the network device 110 may additionally or alternatively perform other types of networking operations such as operate as a switch, a router, a gateway, combinations thereof, and so on.

It should be understood that one or more of the other network devices 110(2), 110(3), . . . may also operate as WAPs. However, there is no requirement that the network devices 110 need to be the same type of equipment. For example, the network device 110(1) may operate as a WAP, the network device 110(2) may operate as a switch, the network device 110(3) may operate as a router, and so on.

It should be appreciated that information technology (IT) administrators may be interested in knowing the availability of a network device 110 over a period of time (a week, a month, etc.). Availability or serviceability of such a device may mean different things in different contexts, but to such an IT administrator it may mean that the device was up and ready to perform network operations. In an example situation, the device under consideration is a Wi-Fi Access Point (WAP). The WAP is said to be available/serviceable when it is up and ready to serve Wi-Fi clients. A WAP is unserviceable when it is either powered down, or booting up, or updating, etc.

To calculate the availability or serviceability and in accordance with certain embodiments, the device maintains certain date/time statistics based on the state of the device. Along these lines, specific statistics are maintained to enable correct and accurate calculation of the available/serviceable time for the device. Note that the statistics are sent to an external entity for calculations.

In accordance with one or more embodiments, the following statistics are periodically provided by the WAP to the external entity for serviceable time calculation:
current date & time
current AP uptime (time since the last AP bootup)

During the serviceable time, the WAP keeps storing the above statistics periodically with a period of T. During unserviceable times, these statistics would not be available. The WAP would restart storing these statistics once it comes back up. These statistics are sent to an external entity (e.g. a cloud server) where it can be processed. Logic within the external entity then correlates/processes these statistics for the calculation/resolution of serviceable and unserviceable time periods.

It should be appreciated that various techniques disclosed herein are able to handle a situation in which the device is not connected to the external entity (for data processing) or connects intermittently, but remains serviceable during these periods. Once the external entity resolves device serviceability, appropriate effort may be directed to address the situation.

For example, a WAP operator may wish to know about the availability/serviceability of deployed Wi-Fi access points. The techniques disclosed herein enable the operator to know about regions where Wi-Fi is unreliable because the devices keep on going into unserviceable periods. Once the operator has identified whether the issue is in the devices or somewhere else, the operator may take steps to report the problem for debugging.

In an example use case, a network device works according to its design but additionally sends certain statistics to an external server for the calculation of serviceable time. The network device can work seamlessly even if the connection to the external server is broken.

The network device is, by way of example, a WAP. Possible scenarios (or states) in the WAP's lifetime where it goes through serviceable and unserviceable periods include:
operating normally while connected to the external server (serviceable)
operating normally while disconnected from the external server (serviceable)
booting up (unserviceable)
powered down (unserviceable)
performing a firmware update (unserviceable)
   Accordingly, the WAP is considered unserviceable while the WAP is powered down, booting up or getting updated. The WAP is considered otherwise serviceable, irrespective of whether it is connected to the external server or not since the WAP can still serve Wi-Fi clients even if the WAP is not connected to the external server (e.g., a cloud/on-prem wireless manager server).

The description herein provides examples for the purposes of understanding and is not intended to limit the invention or the application and uses of the same. Furthermore, there is no intention to be bound by any expressed or implied theory presented herein.

It will be appreciated that the steps of various processes described herein are non-limiting examples of suitable processes according to embodiments and are for the purposes of illustration. Systems and devices according to embodiments herein may use any suitable processes including those that omit steps described above, perform those steps and similar steps in different orders, and the like. It will also be appreciated that well-known features may be omitted for clarity.

Furthermore, it should be understood that the server device 120 was described above as being constructed and arranged to resolve serviceability of one or more network devices 110. However, it should be understood that the server device 120 may communicate with one or more non-network devices and process messages from those devices to resolve serviceability of those devices as well.

Certain embodiments are directed to a method of resolving network device serviceability which can be performed by a network device. The method includes, in response to the network device becoming serviceable, configuring a time tracking circuit to enable indication of a duration of time over which the network device has remained serviceable. The method further includes ascertaining whether the network device is connected with a server device through a network. The method further includes, when the network device is ascertained to be connected with the server device through the network, sending a transmission from the network device to the server device through the network. The transmission indicates the duration of time over which the network device has remained serviceable to enable the server device to determine whether the network device has remained serviceable since a previous time when the network device was confirmed to be serviceable.

Other embodiments are directed to a network device which includes a time tracking circuit, memory, and processing circuitry coupled with the time tracking circuit and the memory. The memory stores instructions which, when carried out by the processing circuitry, cause the processing circuitry to:
(A) in response to the network device becoming serviceable, configure the time tracking circuit to enable indication of an amount of time that elapses while the network device remains serviceable,
(B) ascertain whether the network device is connected with a server device through a network, and
(C) when the network device is ascertained to be connected with the server device through the network, send a transmission from the network device to the server device through the network, the transmission indicating the amount of time that has elapsed while the network device has remained serviceable to enable the server device to determine whether the network device has remained serviceable since a previous time when the network device was confirmed to be serviceable.

Yet other embodiments are directed to a computer program product having a non-transitory computer readable medium which stores a set of instructions to resolve network device serviceability. The set of instructions, when carried out by computerized circuitry, causing the computerized circuitry to perform a method of:
(A) in response to the network device becoming serviceable, configure the time tracking circuit to enable indication of an amount of time that elapses while the network device remains serviceable,
(B) ascertain whether the network device is connected with a server device through a network, and
(C) when the network device is ascertained to be connected with the server device through the network, send a transmission from the network device to the server device through the network, the transmission indicating the amount of time that has elapsed while the network device has remained serviceable to enable the server device to determine whether the network device has remained serviceable since a previous time when the network device was confirmed to be serviceable.

In accordance with one or more embodiments, the network device is constructed and arranged to operate as a wireless access point (WAP). Additionally, sending the transmission includes providing the transmission to the server device while the network device carries out wireless communications with wireless devices to operate as the WAP.

Additionally, certain embodiments are directed to a method of resolving network device serviceability which can be performed by a server device. The method includes receiving a transmission from a network device, the transmission indicating a duration of time over which the network device has remained serviceable. The method further includes accessing a previous timestamp from computerized memory, the previous timestamp indicating a previous time when the network device was confirmed to be serviceable. The method further includes, based on the transmission and the previous timestamp, performing a serviceability resolution operation that provides a serviceability result indicating whether the network device has remained serviceable since the previous time when the network device was confirmed to be serviceable.

Other embodiments are directed to electronic circuitry (such as a server device) to resolve network device serviceability. The electronic circuitry includes a serviceability information repository, memory, and processing circuitry coupled with the serviceability information repository and the memory. The memory stores instructions which, when carried out by the processing circuitry, cause the processing circuitry to perform a method of:
(A) receiving a transmission from a network device, the transmission indicating an amount of time that has elapsed while the network device has remained serviceable,
(B) accessing a previous timestamp from the serviceability information repository, the previous timestamp indicating a previous time when the network device was confirmed to be serviceable, and
(C) based on the transmission and the previous timestamp, performing a serviceability resolution operation that provides a serviceability result indicating whether the network device has remained serviceable since the previous time when the network device was confirmed to be serviceable.

Yet other embodiments are directed to a computer program product having a non-transitory computer readable medium which stores a set of instructions to resolve network device serviceability. The set of instructions, when carried out by computerized circuitry, causes the computerized circuitry to perform a method of:
(A) receiving a transmission from a network device, the transmission indicating an amount of time that has elapsed while the network device has remained serviceable;
(B) accessing a previous timestamp from computerized memory, the previous timestamp indicating a previous time when the network device was confirmed to be serviceable; and
(C) based on the transmission and the previous timestamp, performing a serviceability resolution operation that provides a serviceability result indicating whether the network device has remained serviceable since the previous time when the network device was confirmed to be serviceable.

In accordance with one or more embodiments, performing the serviceability resolution operation includes:
(i) generating a start-of-serviceability timestamp based on the transmission, the start-of-serviceability timestamp indicating a start-of-serviceability time when the network device became serviceable; and
(ii) performing a timestamp comparison operation which compares the start-of-serviceability timestamp with the previous timestamp to ascertain whether the network device has remained serviceable since the previous time when the network device was confirmed to be serviceable.

In accordance with one or more embodiments, the transmission includes a current message transmitted by the network device over a network. Additionally, generating the start-of-serviceability timestamp includes:
(i) extracting an uptime parameter from the current message, the uptime parameter indicating the amount of time that has elapsed while the network device has remained serviceable,
(ii) extracting a current timestamp from the current message, the current timestamp indicating a time when the uptime parameter was included within the current message, and
(iii) subtracting the amount of time indicated by the uptime parameter from the time indicated by the current timestamp to generate the start-of-serviceability timestamp.

In accordance with one or more embodiments, performing the timestamp comparison operation includes providing a comparison result which indicates (i) serviceability continuity since the previous time when the network device was confirmed to be serviceable in response to the start-of-serviceability timestamp identifying a time at or before that of the previous timestamp, and (ii) serviceability discontinuity since the previous time when the network device was confirmed to be serviceable in response to the start-of-serviceability timestamp identifying a time after that of the previous timestamp.

In accordance with one or more embodiments, the method further includes, in response to the timestamp comparison operation indicating that the network device did not remain serviceable since the previous time, performing a quantification operation to quantify an amount of time that the network device was unserviceable since the previous time.

In accordance with one or more embodiments, performing the quantification operation includes subtracting the previous timestamp from the start-of-serviceability timestamp to generate an unserviceable time parameter indicating the amount of time that the network device was unserviceable since the previous time.

In accordance with one or more embodiments, the method further includes:
(A) after performing the serviceability resolution operation that provides the serviceability result, replacing the previous timestamp in the computerized memory with a new timestamp indicating a new time when the network device was confirmed to be serviceable;
(B) receiving another transmission from the network device, the other transmission indicating an updated amount of time that has elapsed while the network device has remained serviceable;
(C) accessing the new timestamp from computerized memory, the new timestamp indicating the new time when the network device was confirmed to be serviceable; and
(D) based on the transmission and the previous timestamp, performing another serviceability resolution operation that provides another serviceability result indicating whether the network device has remained serviceable since the new time when the network device was confirmed to be serviceable.

In accordance with one or more embodiments, the method further includes:
(A) receiving another transmission from another network device, the other transmission indicating an amount of time that has elapsed while the other network device has remained serviceable;
(B) accessing another previous timestamp from computerized memory, the other previous timestamp indicating another previous time when the other network device was confirmed to be serviceable; and
(C) based on the other transmission and the other previous timestamp, performing another serviceability resolution operation that provides another serviceability result indicating whether the other network device has remained serviceable since the other previous time when the other network device was confirmed to be serviceable.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Also, the foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematics and component features shown in the figures depict one exemplary arrangement of elements, additional intervening elements, devices, features, or components may be present in one or more other embodiments of the depicted subject matter.

Those skilled in the art will therefore understand that various changes in form and detail may be made to the embodiments disclosed herein without departing from the scope of the following claims.

What is claimed is:

1. A method of resolving network device serviceability, the method comprising:
receiving a transmission from a network device, the transmission indicating a duration of time over which the network device has remained serviceable;
accessing a previous timestamp from computerized memory, the previous timestamp indicating a previous time when the network device was confirmed to be serviceable; and
based on the transmission and the previous timestamp, performing a serviceability resolution operation that provides a serviceability result indicating whether the network device has remained serviceable since the previous time when the network device was confirmed to be serviceable.

2. The method of claim 1, wherein performing the serviceability resolution operation includes:
generating a start-of-serviceability timestamp based on the transmission, the start-of-serviceability timestamp indicating a start-of-serviceability time when the network device became serviceable; and
performing a timestamp comparison operation which compares the start-of-serviceability timestamp with the previous timestamp to ascertain whether the network device has remained serviceable since the previous time when the network device was confirmed to be serviceable.

3. The method of claim 2, wherein the transmission includes a current message transmitted by the network device over a network; and
wherein generating the start-of-serviceability timestamp includes:
extracting an uptime parameter from the current message, the uptime parameter indicating the duration of time over which the network device has remained serviceable,
extracting a current timestamp from the current message, the current timestamp indicating a time when the uptime parameter was included within the current message, and
subtracting the duration of time indicated by the uptime parameter from the time indicated by the current timestamp to generate the start-of-serviceability timestamp.

4. The method of claim 2, wherein performing the timestamp comparison operation includes:
providing a comparison result which indicates (i) serviceability continuity since the previous time when the network device was confirmed to be serviceable in response to the start-of-serviceability timestamp identifying a time at or before that of the previous timestamp, and (ii) serviceability discontinuity since the previous time when the network device was confirmed to be serviceable in response to the start-of-serviceability timestamp identifying a time after that of the previous timestamp.

5. The method of claim 2, further comprising:
in response to the timestamp comparison operation indicating that the network device did not remain serviceable since the previous time, performing a quantification operation to quantify an amount of time that the network device was unserviceable since the previous time.

6. The method of claim 5, wherein performing the quantification operation includes:
subtracting the previous timestamp from the start-of-serviceability timestamp to generate an unserviceable time parameter indicating the amount of time that the network device was unserviceable since the previous time.

7. The method of claim 1, further comprising:
after performing the serviceability resolution operation that provides the serviceability result, replacing the previous timestamp in the computerized memory with a new timestamp indicating a new time when the network device was confirmed to be serviceable;
receiving another transmission from the network device, the other transmission indicating an updated duration of time over which the network device has remained serviceable;
accessing the new timestamp from computerized memory, the new timestamp indicating the new time when the network device was confirmed to be serviceable; and
based on the transmission and the previous timestamp, performing another serviceability resolution operation that provides another serviceability result indicating whether the network device has remained serviceable since the new time when the network device was confirmed to be serviceable.

8. The method of claim 7, further comprising:
receiving another transmission from another network device, the other transmission indicating a duration of time over which the other network device has remained serviceable;
accessing another previous timestamp from computerized memory, the other previous timestamp indicating another previous time when the other network device was confirmed to be serviceable; and
based on the other transmission and the other previous timestamp, performing another serviceability resolution operation that provides another serviceability result indicating whether the other network device has remained serviceable since the other previous time when the other network device was confirmed to be serviceable.

9. A computer program product having a non-transitory computer readable medium which stores a set of instructions to resolve network device serviceability; the set of instructions, when carried out by computerized circuitry, causing the computerized circuitry to perform a method of:
receiving a transmission from a network device, the transmission indicating an amount of time that has elapsed while the network device has remained serviceable;
accessing a previous timestamp from computerized memory, the previous timestamp indicating a previous time when the network device was confirmed to be serviceable; and
based on the transmission and the previous timestamp, performing a serviceability resolution operation that provides a serviceability result indicating whether the network device has remained serviceable since the previous time indicated by the previous timestamp.

10. The computer program product of claim 9, wherein performing the serviceability resolution operation includes:
generating a start-of-serviceability timestamp based on the transmission, the start-of-serviceability timestamp indicating a start-of-serviceability time when the network device became serviceable; and
performing a timestamp comparison operation which compares the start-of-serviceability timestamp with the previous timestamp to ascertain whether the network device has remained serviceable since the previous time indicated by the previous timestamp.

11. The computer program product of claim 10, wherein the transmission includes a
current message transmitted by the network device over a network; and wherein generating the start-of-serviceability timestamp includes:
extracting an uptime parameter from the current message, the uptime parameter indicating the amount of time that has elapsed while the network device has remained serviceable,
extracting a current timestamp from the current message, the current timestamp indicating a time when the uptime parameter was included within the current message, and
subtracting the amount of time indicated by the uptime parameter from the time indicated by the current timestamp to generate the start-of-serviceability timestamp.

12. The computer program product of claim 10, wherein the performing the timestamp comparison operation includes:
providing a comparison result which indicates (i) serviceability continuity since the previous time indicated by the previous timestamp in response to the start-of-serviceability timestamp identifying a time at or before that of the previous timestamp, and (ii) serviceability discontinuity since the previous time indicated by the previous timestamp in response to the start-of-serviceability timestamp identifying a time after that of the previous timestamp.

13. The computer program product of claim 10, wherein the method further comprises:
in response to the timestamp comparison operation indicating that the network device did not remain serviceable since the previous time, performing a quantification operation to quantify an amount of time that the network device was unserviceable since the previous time.

14. The computer program product of claim 13, wherein performing the quantification operation includes:
subtracting the previous timestamp from the start-of-serviceability timestamp to generate an unserviceable time parameter indicating the amount of time that the network device was unserviceable since the previous time.

15. The computer program product of claim 14, wherein the serviceability resolution operation is performed on a server device which is external to the network device;
wherein the transmission includes a current message transmitted by the network device over a network; and
wherein performing the quantification operation includes:
extracting a set of disconnection entries from the current message, the set of disconnection entries identifying a set of disconnection time periods during which the network device was serviceable and disconnected from the server device,
computing an overall amount of time during which the network device was serviceable and disconnected from the server device based on the set of disconnection time periods; and
subtracting, from the start-of-serviceability timestamp, (i) the previous timestamp and (ii) the overall amount of time during which the network device was serviceable and disconnected from the server device to generate an unserviceable time parameter indicating the amount of time that the network device was unserviceable since the previous time.

16. The computer program product of claim 9, wherein the method further comprises:
after performing the serviceability resolution operation that provides the serviceability result, replacing the previous timestamp in the computerized memory with a new timestamp indicating a new time when the network device was confirmed to be serviceable.

17. The computer program product of claim 16, wherein the method further comprises:
receiving another transmission from the network device, the other transmission indicating an updated amount of time that has elapsed while the network device has remained serviceable;
accessing the new timestamp from computerized memory, the new timestamp indicating the new time when the network device was confirmed to be serviceable; and
based on the transmission and the previous timestamp, performing another serviceability resolution operation that provides another serviceability result indicating whether the network device has remained serviceable since the new time when the network device was confirmed to be serviceable.

18. The computer program product of claim 9, wherein the method further comprises:
receiving another transmission from another network device, the other transmission indicating an amount of time that has elapsed while the other network device has remained serviceable;
accessing another previous timestamp from computerized memory, the other previous timestamp indicating another previous time when the other network device was confirmed to be serviceable; and
based on the other transmission and the other previous timestamp, performing another serviceability resolution operation that provides another serviceability result indicating whether the other network device has remained serviceable since the other previous time when the other network device was confirmed to be serviceable.

19. A network device, comprising:
a time tracking circuit;
memory;
processing circuitry coupled with the time tracking circuit and the memory, the memory storing instructions which, when carried out by the processing circuitry, cause the processing circuitry to:
in response to the network device becoming serviceable, configure the time tracking circuit to enable indication of a duration of time over which the network device has remained serviceable,
ascertain whether the network device is connected with a server device through a network, and
when the network device is ascertained to be connected with the server device through the network, send a transmission from the network device to the server device through the network, the transmission indicating the duration of time over which the network device has remained serviceable to enable the server device to determine whether the network device has remained serviceable since a previous time when the network device was confirmed to be serviceable.

20. The network device of claim 19, wherein the network device is constructed and arranged to operate as a wireless access point (WAP); and
wherein the processing circuitry, when sending the transmission, is constructed and arranged to:
provide the transmission to the server device while the network device carries out wireless communications with wireless devices to operate as the WAP.
